(19) United States
(12) Patent Application Publication
(10) Pub. No.: US 2002/0172440 A1
(43) Pub. Date: Nov. 21, 2002

(54) Bearing assembly

(76) Inventor: Chin-Sung Oa, Taichung (TW)

Correspondence Address: Chin-Sung Oa, 58, MA YUAN WEST ST., TAICHUNG, TW

(21) Appl. No.: 09/863,990

(22) Filed: May 21, 2001

(51) Int. Cl. F16C 33/76

(52) U.S. Cl. 384/477; 384/486

(57) ABSTRACT

A bearing assembly has a sleeve, a first ball-receiving chain enclosing the sleeve, a second ball-receiving chain enclosing the sleeve, the first ball-receiving chain engaging with the second ball-receiving chain, a collar, a first gasket, a second gasket, a first rubber washer, and a second rubber washer. The first gasket, the sleeve, and the second gasket are inserted in the collar. The first rubber washer encloses the sleeve. The second rubber washer encloses the sleeve. The first ball-receiving chain and the second ball-receiving chain receive a plurality of balls.

### BACKGROUND OF THE INVENTION

The present invention relates to a bearing assembly. More particularly, the present invention relates to a bearing assembly which has a low friction, a dust-proof, and a water-resisting functions.

A conventional bearing device cannot perform a dust-proof and a water-resisting functions after a long period of usage. Therefore, the conventional bearing device will be rusted and broken after a long period of usage.

### SUMMARY OF THE INVENTION

An object of the present invention is to provide a bearing assembly which has a low friction function.

Another object of the present invention is to provide a bearing assembly which is dust-proof.

Another object of the present invention is to provide a bearing assembly which is water-resisting.

Accordingly, a bearing assembly comprises a sleeve, a first ball-receiving chain enclosing the sleeve, a second ball-receiving chain enclosing the sleeve, the first ball-receiving chain engaging with the second ball-receiving chain, a collar, a first gasket, a second gasket, a first rubber washer, and a second rubber washer. The first gasket, the sleeve, and the second gasket are inserted in the collar. The first rubber washer encloses the sleeve. The second rubber washer encloses the sleeve. The first ball-receiving chain and the second ball-receiving chain receive a plurality of balls. The first rubber washer has a first annular bevel and a first annular flange. The second rubber washer has a second annular bevel and a second annular flange. A first rubber film encloses the first gasket. A second rubber film encloses the second gasket. The first annular bevel contacts the first rubber film. The second annular bevel contacts the second rubber film.

### BRIEF DESCRIPTION OF THE DRAWINGS

FIG. 1 is a perspective exploded view of a bearing assembly of a first preferred embodiment in accordance with the present invention;

FIG. 2 is a sectional assembly view of a bearing assembly of a first preferred embodiment in accordance with the present invention;

FIG. 3 is a perspective exploded view of a bearing assembly of a second preferred embodiment in accordance with the present invention;

FIG. 4 is a sectional assembly view of a bearing assembly of a second preferred embodiment in accordance with the present invention;

FIG. 5 is a sectional assembly view of a bearing assembly of a third preferred embodiment in accordance with the present invention; and

FIG. 6 is a perspective schematic view illustrating a bearing assembly of a first preferred embodiment disposed in a bearing block.

### DETAILED DESCRIPTION OF THE INVENTION

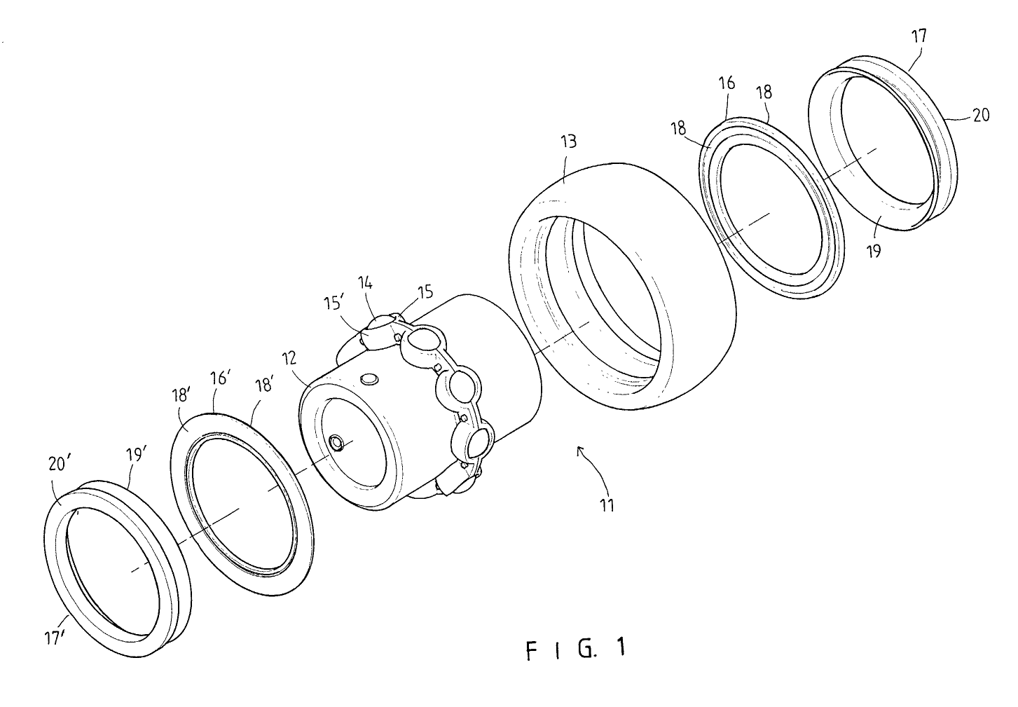

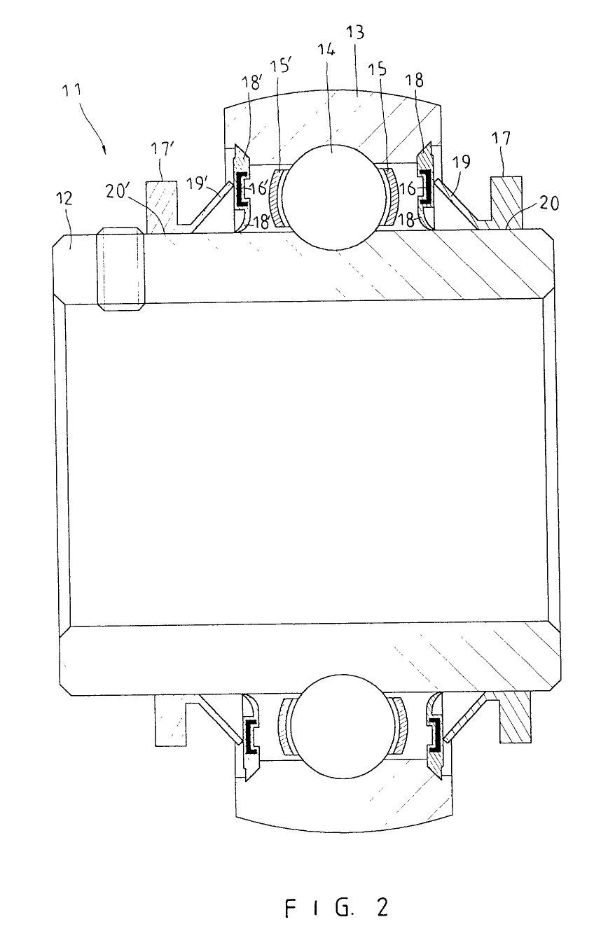

Referring to FIGS. 1 and 2, a first bearing assembly 11 comprises a sleeve 12, a first ball-receiving chain 15 enclosing the sleeve 12, a second ball-receiving chain 15′ enclosing the sleeve 12, the first ball-receiving chain 15 engaging with the second ball-receiving chain 15′, a collar 13, a first gasket 16, a second gasket 16′, a first rubber washer 17, and a second rubber washer 17′.

The first gasket 16, the sleeve 12, and the second gasket 16′ are inserted in the collar 13 to seal the collar 13 tightly. The first rubber washer 17 encloses the sleeve 12. The first rubber washer 17 and the sleeve 12 are adhered together. The second rubber washer 17′ encloses the sleeve 12. The second rubber washer 17′ and the sleeve 12 are adhered together.

The first ball-receiving chain 15 and the second ball-receiving chain 15′ receive a plurality of balls 14.

The first rubber washer 17 has a first annular bevel 19 and a first annular flange 20.

The second rubber washer 17′ has a second annular bevel 19′ and a second annular flange 20′.

A first rubber film 18 encloses the first gasket 16. A second rubber film 18′ encloses the second gasket 16′.

The first annular bevel 19 contacts the first rubber film 18. The second annular bevel 19′ contacts the second rubber film 18′. The first annular flange 20 and the second annular flange 20′ enclose the sleeve 12 tightly.

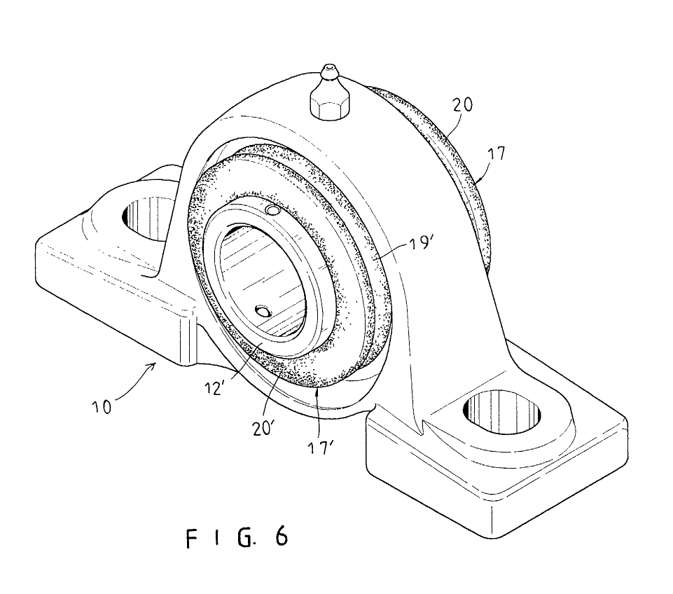

Referring to FIG. 6, the bearing assembly 11 is disposed in a bearing block 10.

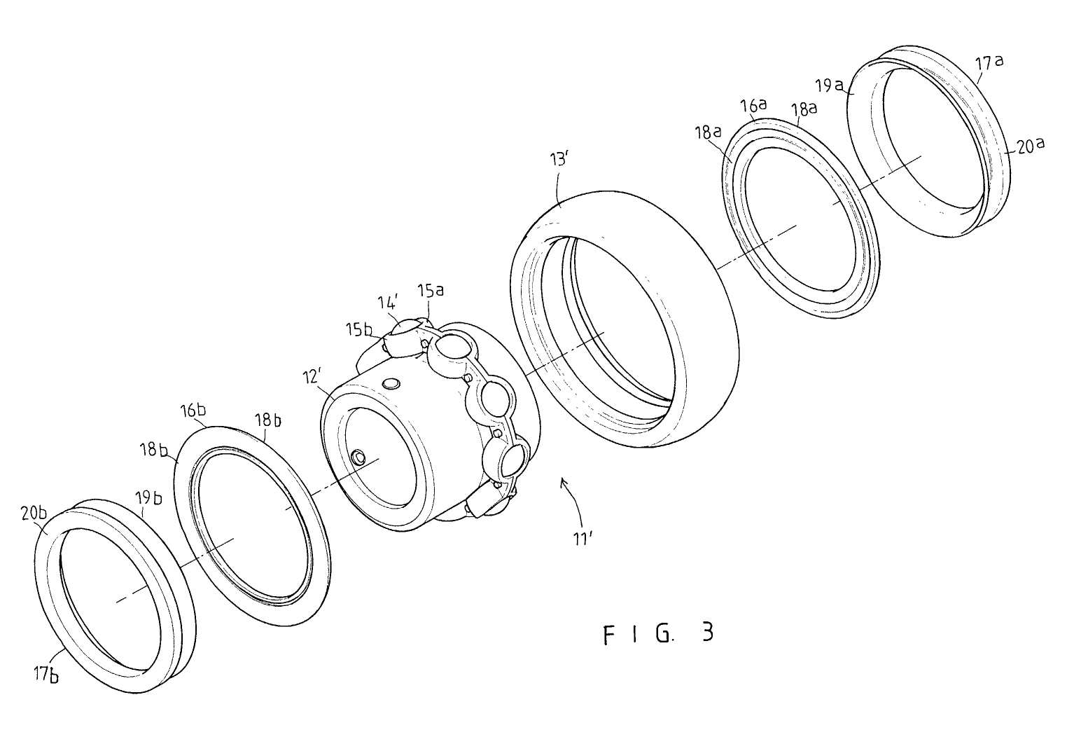

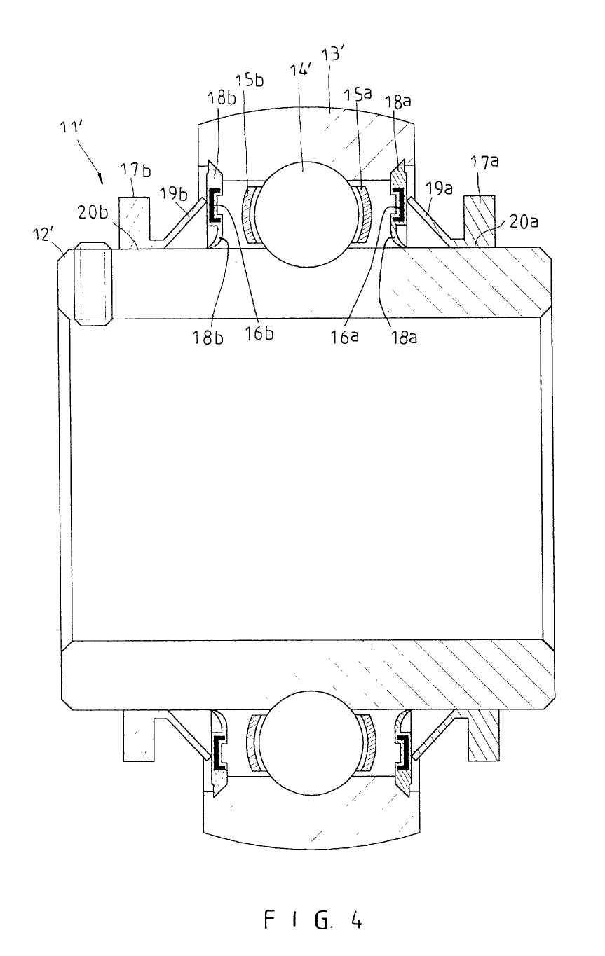

Referring to FIGS. 3 and 4, a second bearing assembly 11′ comprises a sleeve 12′, a first ball-receiving chain 15a enclosing the sleeve 12′, a second ball-receiving chain 15b enclosing the sleeve 12′, the first ball-receiving chain 15a engaging with the second ball-receiving chain 15b, a collar 13′, a first gasket 16a, a second gasket 16b, a first rubber washer 17a, and a second rubber washer 17b.

The first gasket 16a, the sleeve 12′, the second gasket 16b, the first rubber washer 17a, and the second rubber washer 17b are inserted in the collar 13′.

The first ball-receiving chain 15a and the second ball-receiving chain 15b receive a plurality of balls 14′.

The first rubber washer 17a has a first annular bevel 19a and a first annular flange 20a.

The second rubber washer 17b has a second annular bevel 19b and a second annular flange 20b.

A first rubber film 18a encloses the first gasket 16a.

A second rubber film 18b encloses the second gasket 16b.

The first annular bevel 19a contacts the first rubber film 18a.

The second annular bevel 19b contacts the second rubber film 18b.

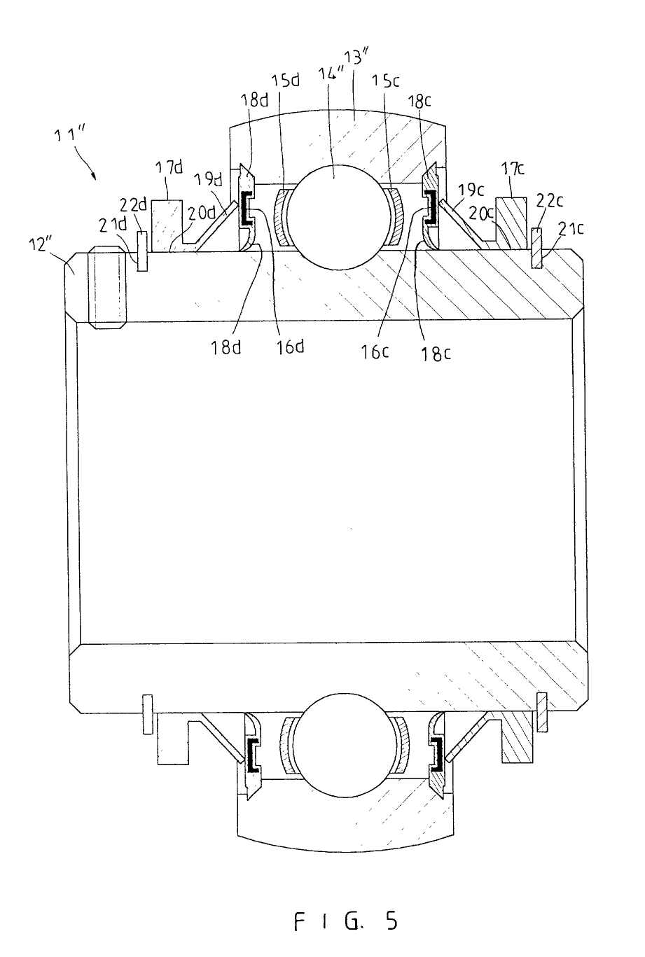

Referring to FIG. 5, a third bearing assembly 11″ comprises a sleeve 12″, a first ball-receiving chain 15c enclosing the sleeve 12″, a second ball-receiving chain 15d enclosing the sleeve 12″, the first ball-receiving chain 15c engaging with the second ball-receiving chain 15d, a collar 13″, a first gasket 16c, a second gasket 16d, a first rubber washer 17c, and a second rubber washer 17d.

The first gasket 16c, the sleeve 12″, and the second gasket 16d are inserted in the collar 13″.

The first rubber washer 17c encloses the sleeve 12″.

The second rubber washer 17d encloses the sleeve 12″.

The first ball-receiving chain 15c and the second ball-receiving chain 15d receive a plurality of balls 14″.

The first rubber washer 17c has a first annular bevel 19c and a first annular flange 20c.

The second rubber washer 17d has a second annular bevel 19d and a second annular flange 20d.

A first rubber film 18c encloses the first gasket 16c.

A second rubber film 18d encloses the second gasket 16d.

The first annular bevel 19c contacts the first rubber film 18c.

The second annular bevel 19d contacts the second rubber film 18d.

The collar 13″ has a first annular groove 21c and a second annular groove 21d.

A first clamping ring 22c is inserted in the first annular groove 21c.

A second clamping ring 22d is inserted in the second annular groove 21d.

The invention is not limited to the above embodiment but various modification thereof may be made. Further, various changes in form and detail may be made without departing from the scope of the invention.

I claim:

1. A bearing assembly comprises:
a sleeve, a first ball-receiving chain enclosing the sleeve, a second ball-receiving chain enclosing the sleeve, the first ball-receiving chain engaging with the second ball-receiving chain, a collar, a first gasket, a second gasket, a first rubber washer, and a second rubber washer,
the first gasket, the sleeve, and the second gasket inserted in the collar,
the first rubber washer enclosing the sleeve,
the second rubber washer enclosing the sleeve,
the first ball-receiving chain and the second ball-receiving chain receiving a plurality of balls,
the first rubber washer having a first annular bevel and a first annular flange,
the second rubber washer having a second annular bevel and a second annular flange,
a first rubber film enclosing the first gasket, a second rubber film enclosing the second gasket,
the first annular bevel contacting the first rubber film, and
the second annular bevel contacting the second rubber film.

2. The bearing assembly as claimed in claim 1, wherein the collar has a first annular groove and a second annular groove, a first clamping ring is inserted in the first annular groove, and a second clamping ring is inserted in the second annular groove.

3. The bearing assembly as claimed in claim 1, wherein the first rubber washer and the sleeve are adhered together.

4. The bearing assembly as claimed in claim 1, wherein the second rubber washer and the sleeve are adhered together.
